(19) United States
(12) Patent Application Publication
(10) Pub. No.: US 2024/0362281 A1
(43) Pub. Date: Oct. 31, 2024

(54) COMMUNICATION BETWEEN A TERMINAL AND A COMMUNICATION EQUIPMENT, VIA A COMMUNICATION NETWORK

(71) Applicant: Orange, Issy-les-Moulineaux (FR)

(72) Inventors: Fabrice BOUDIN, CHATILLON CEDEX (FR); Arnaud BRUN, CHATILLON CEDEX (FR)

(21) Appl. No.: 18/618,517

(22) Filed: Mar. 27, 2024

(30) Foreign Application Priority Data
Mar. 28, 2023 (FR) 2302945

(51) Int. Cl. G06F 16/9535; H04L 67/306

(52) U.S. Cl. CPC G06F 16/9535; H04L 67/306

(57) ABSTRACT

A method for communication between a terminal and a communication equipment, via a communication network, is described. The method includes transmitting, from the terminal to the equipment, via the network, a search request for a public place, the request including the type of place and at least one word characterizing the type, the at least one word being associated with a first intensity value assigned to at least one human sense. The method also includes selecting, in the network, one or more public places for which a second intensity value for said at least one sense has been assigned and the second value of which is closest to the first value, and, in response to the request, receiving at the terminal a content item from the equipment including identification information in relation to the selected place/places.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to French Patent Application No. 2302945, filed on Mar. 28, 2023, the disclosure of which is hereby incorporated by reference in its entirety.

### BACKGROUND

### Technical Field

The disclosed technology is in the field of communication of data between a user terminal and a communication equipment, via a communication network, with a view to receiving one or more content items in the terminal. A content item is understood to mean text, sound (or audio), images, videos, or any combination of these various elements.

### Description of the Related Art

Many existing tools (platforms accessible via websites and/or mobile applications) allow a user to obtain personalized recommendations (for example for restaurants, movies, etc.) using various criteria. Using their terminal, a user carries out a search, indicating certain criteria. For example, in the case of searching for a public place, in particular a restaurant, the criteria that are used are for example desired location, desired opening hours, visitor numbers, accessibility to people with disabilities, etc. The website “TheFork” (https://www.thefork.fr) offers a tool for recommending public places such as restaurants, allowing personalized recommendation and reservation of restaurants, using various criteria, such as for example the desired type of cuisine (for example French, Japanese, Indian, etc.), the location of the restaurant, the average price of a lunch, etc.

Some of these existing recommendation tools allow the user to define a personal profile. This profile contains information relating to the user such as their age, their gender, their place of residence, but also sometimes information relating to their lifestyle (for example, their hobbies), or even their tastes (for example, their musical tastes, literary tastes, etc.), etc. The drawback of such a profile is that it contains personal data regarding the user that could be exploited fraudulently, such as in particular age, gender, place of residence.

However, the abovementioned recommendation tools are limited in that they do not allow a user to search for places open to the public according to sensory considerations based on at least one of the human senses (smell, sight, hearing, taste, touch), these often being considered to be as important to the user as the other criteria that are usually used, such as the location of the place for example. The user is thus unable, with current tools for recommending public places, to submit the following exemplary requests:
“I would like to have lunch with my friend, do you know of a quiet restaurant in the city center?”
“I hate the strong smell of chlorine in my swimming pool; do you know of another one that wouldn't have this problem?”
“I hate the halogen lighting in my gym, can anyone recommend a venue with less aggressive lighting?”

Moreover, besides the fact that tools for recommending public places are limited in terms of criteria selection, they are also unsuitable for many people who have atypical sensory needs or requirements, for example because of a disability. For these people, the usual tools for recommending public places, which do not take into account any sensory criteria (for example the desired ambient noise level), are not satisfactory. Examples of such people include:
people suffering from photophobia, which is characterized by increased sensitivity to light, or even complete intolerance thereto (excessively bright light may cause these people visual discomfort, eye problems—eye dryness and/or eye pain for example—migraines, etc.);
people suffering from hyperacusis (also called auditory hypersensitivity), which is an intolerance or low tolerance to everyday environmental noise and is often associated with tinnitus, ringing in the ears;
people suffering from hyperosmia, characterized by an increase in olfactory capacity;
people suffering from parosmia, which is characterized by a distortion of one smell toward another, usually unpleasant smell;
people having a low tolerance to rich and spicy food;
etc.

For all these people, a tool for recommending places according to sensory criteria would be particularly useful.

### SUMMARY

One of the aims of the disclosed technology is to rectify at least one of the drawbacks of the abovementioned tools by proposing to search, using a terminal, via a communication network, for places open to the public, such a search being carried out based on sensory criteria specific to the user.

To this end, one subject of the present disclosed technology relates to a method for communication between a terminal and a communication equipment, via a communication network, during which the terminal requests to obtain a content item from the equipment, such a content item relating to a place open to the public.

This communication method is characterized in that it implements the following:
transmission, from the terminal to said equipment, via said network, of a search request for at least one place open to the public, said request comprising at least one type of place and at least one word characterizing the type of place, said at least one word being associated with a first intensity value assigned to at least one human sense,
selection, in said network, of one or more places open to the public for which a second intensity value for said at least one sense has been assigned and the second value of which is closest to the first value,
in response to the request, reception, in the terminal, from said equipment, of a content item comprising identification information in relation to the selected one or more places.

Such a communication method advantageously makes it possible to implement a personalized content recommendation tool based on sensory criteria of a user. More precisely, the disclosed technology is capable of recommending places open to the public (for example restaurants, gyms, shops, public gardens, beaches, etc.) to a user on the basis of sensory criteria that are specific to this user and that have been defined beforehand by said user. Such a method is particularly useful for users having atypical sensory needs or requirements, for example due to a disability, in particular users suffering from photophobia, hyperacusis, hyperosmia, parosmia, etc.

According to one particular embodiment,
the first intensity value for said at least one sense belongs to a profile of a user of the terminal, such a profile containing sensory preferences of the user in relation to one or more human senses,
the second intensity value for said at least one sense belongs to a profile of at least one place, such a profile containing sensory characteristics specific to the place, in relation to one or more human senses.

Such an embodiment makes it possible to define sensory criteria in the form of a profile that is adapted both to the user and to the place open to the public, by being based on intensity values for at least one human sense.

According to another particular embodiment, the profile of the user of the terminal is generated in one go prior to the implementation of the method or is generated in association with each search request.

Such an embodiment makes it possible to generate a profile:
either once and for all, such a profile then being systematically taken into account upon each search for places open to the public submitted by the user using their terminal,
or more dynamically, upon each search for places open to the public submitted by the user using their terminal.

According to another particular embodiment, the profile of the user of the terminal is generated from responses of the user to a digital questionnaire received by the terminal or another terminal, the questionnaire interrogating the user about their preferences in relation to at least one human sense.

Such an embodiment allows the user to manually and accurately define their sensory preferences, by virtue of filling in a digital questionnaire that serves as a guide for them when defining their sensory profile.

According to another particular embodiment, the profile of the user of the terminal is generated from one or more messages of the user that have been published, via the communication network, the one or more messages relating to one or more places open to the public, in relation to at least some human senses.

Such an embodiment has the advantage of not calling on the user in order to define the sensory profile of said user, such a sensory profile being generated automatically using messages left by the user, via the communication network, the messages containing information about one or more places open to the public, such as for example an opinion about the smell of chlorine in a swimming pool, a publication about a very noisy shop, a score assigned to a public park that smells of resin, etc.

According to another particular embodiment, the profile of the user of the terminal is generated from one or more digital traces left by the user, during one or more communications using the terminal, via the communication network.

Such an embodiment has the advantage of not calling on the user in order to define the sensory profile of said user, such a sensory profile being generated automatically using digital traces left by the user, via the communication network, such as for example cookies, data from the call log of the terminal of the user, geolocation information in relation to the user, etc. Such digital traces are intended to be correlated with intensity values for at least one sense, thus defining the sensory profile of the user.

According to another particular embodiment, the first intensity value for said at least one sense of the profile of the user of the terminal, respectively the second intensity value for said at least one sense of the profile of said at least one place, are variable or invariable over time.

The various abovementioned embodiments or implementation features may be added, independently or in combination with one another, to the communication method as defined above.

The disclosed technology also relates to a method for communication between a communication terminal and a communication equipment, via a communication network, during which the terminal requests to obtain a content item from said equipment, said content item relating to a place open to the public.

Such a communication method is characterized in that it implements the following on the terminal:
transmission, to said communication equipment, via said network, of a search request for at least one place open to the public, said request comprising at least one type of place open to the public and at least one word characterizing said type of place, said at least one word being associated with a first intensity value assigned to at least one human sense,
in response to the request, reception, from said equipment, via said network, of a content item comprising identification information in relation to one or more places for which a second intensity value for said at least one sense has been assigned and the second value of which is closest to the first value.

The disclosed technology also relates to a communication terminal designed to communicate, via a communication network, with a communication equipment, during which the terminal requests to obtain a content item from said equipment, said content item relating to a place open to the public.

Such a terminal is characterized in that it is configured to:
transmit, to said communication equipment, via said network, a search request for at least one place open to the public, said request comprising at least one type of place open to the public and at least one word characterizing said type of place, said at least one word being associated with a first intensity value assigned to at least one human sense,
in response to the request, receive, from said equipment, via said network, a content item comprising identification information in relation to one or more places for which a second intensity value for said at least one sense has been assigned and the second value of which is closest to the first value.

The disclosed technology also relates to a communication equipment designed to communicate, via a communication network, with a communication terminal, during which the terminal requests to obtain a content item from said equipment, said content item relating to a place open to the public.

Such an equipment is characterized in that it is configured to:
receive, from the terminal, via said network, a search request for at least one place open to the public, said request comprising at least one type of place open to the public and at least one word characterizing said type of place, said at least one word being associated with a first intensity value assigned to at least one human sense,
select, in said network, one or more places open to the public for which a second intensity value for said at least one sense has been assigned and the second value of which is closest to the first value,
in response to the request, transmit, to said terminal, via said network, a content item comprising identification information in relation to the selected one or more places open to the public.

The disclosed technology also relates to a computer program comprising instructions for implementing the communication method in accordance with the disclosed technology, according to any one of the particular embodiments described above, when said program is executed by a processor.

Such instructions may be stored durably in a non-transient memory medium of the content reception device implementing the communication method according to the disclosed technology.

This program may use any programming language and be in the form of source code, object code or intermediate code between source code and object code, such as in a partially compiled form, or in any other desirable form.

The disclosed technology also targets a computer-readable recording medium or information medium comprising instructions of a computer program as mentioned above.

The recording medium may be any entity or device capable of storing the program. For example, the medium may comprise a storage means, such as a ROM, for example a CD-ROM or a microelectronic circuit ROM, or even a magnetic storage means, for example a mobile medium, a hard disk or an SSD.

Furthermore, the recording medium may be a transmissible medium such as an electrical or optical signal, which may be routed via an electrical or optical cable, by radio or by other means, such that the computer program that it contains is able to be executed remotely. The program according to the disclosed technology may in particular be downloaded from a network, for example an Internet network.

As an alternative, the recording medium may be an integrated circuit in which the program is incorporated, the circuit being designed to execute or to be used in the execution of the abovementioned communication method.

According to one exemplary embodiment, the present technique is implemented by way of software components and/or hardware components. With this in mind, the term “device” or “module” may correspond in this document equally to a software component, to a hardware component or to a set of software components and hardware components.

### BRIEF DESCRIPTION OF THE DRAWINGS

Other features and advantages will become apparent from reading particular embodiments of the disclosed technology, which are given by way of illustrative and non-limiting examples, and the appended drawings.

FIG. 1 shows an architecture in which the communication method is implemented, according to one particular embodiment of the disclosed technology.

FIG. 2 shows a communication terminal, according to one particular embodiment of the disclosed technology, as implemented in the architecture of FIG. 1.

FIG. 3 shows a communication equipment, according to one particular embodiment of the disclosed technology, as implemented in the architecture of FIG. 1.

FIG. 4A shows the main actions implemented in the communication method according to one particular embodiment of the disclosed technology, as implemented in the architecture of FIG. 1,

FIG. 4B shows the main actions implemented in the communication method according to one particular embodiment of the disclosed technology, as implemented in the architecture of FIG. 1.

### DETAILED DESCRIPTION

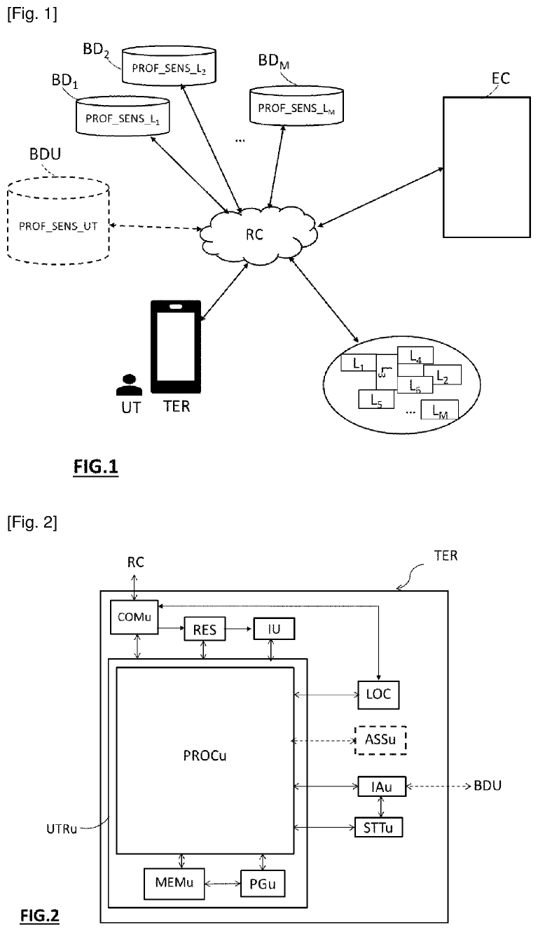

FIG. 1 shows an architecture in which a communication method is implemented, according to one embodiment of the disclosed technology.

Such an architecture comprises:
a terminal TER of a user UT who wishes to search, using their terminal TER, for one or more places L₁, L₂, . . . , L_{M} (M≥1) open to the public, in accordance with one or more sensory criteria specific to the user UT;
a communication equipment EC with which the terminal TER communicates via a communication network RC in order to carry out its search;
a storage module BDU storing a sensory profile PROF_SENS_UT associated with the user UT,
one or more storage modules BD₁, BD₂, . . . , BD_{M} storing sensory profiles PROF_SENS_L₁, PROF_SENS_L₂, . . . , PROF_SENS_L_{M} associated, respectively, with the places L₁, L₂, . . . , L_{M} open to the public.

The storage module BDU is optional. For this reason, it is shown in dashed lines in FIG. 1.

The terminal TER is for example a smartphone, a tablet, a connected watch, a computer, etc.

The communication equipment EC is for example a server, a platform, etc. and is configured to receive, from the terminal TER, via the network RC, a search request for at least one place open to the public.

In the example shown, the storage module BDU is a database installed in the communication network RC or in another network (not shown) communicating with the communication network RC. In another exemplary embodiment, the storage module BDU could be integrated into the terminal TER.

In the example shown, the storage modules BD₁, BD₂, . . . , BD_{M} are databases installed in the network RC or in another network (not shown) communicating with the communication network RC.

The communication network RC is implemented for example using cellular radio telephony technology (3G, 4G, 5G for example), IP (Internet Protocol) technology, circuit-switched technology, Wi-Fi technology, etc., or a combination of these technologies.

“Sensory” is understood to mean anything relating to at least one human sense, such as smell, sight, hearing, taste, touch.

In the remainder of the description, for the sake of simplicity, a “place open to the public” will be called a “public place”. This may be an outdoor public place, for example a public garden, a tennis court, a square in a neighborhood of a city, etc. or an indoor public place, for example a restaurant, a gym, a shop, a museum, etc.

The simplified structure of the terminal TER will now be described with reference to FIG. 2.

Such a terminal has the conventional architecture of a mobile terminal such as a smartphone, a tablet, a computer or the like.

To this end, the TER terminal comprises:
a user interface IU configured for the textual or oral entry of information or to render information (keyboard, mouse, microphone, screen, loudspeaker, camera, etc.),
a communication interface COMu configured to communicate, via the communication network RC of FIG. 1, with the communication equipment EC,
a geolocation module LOC that operates for example using GPS (Global Positioning System) technology, Galileo technology, Wi-Fi technology, GSM (Global System for Mobile Communications) technology, IP technology, etc.
a memory STTu configured to store:
   data relating to the use of the terminal TER, for example cookies, data from a call log, one or more messages posted by the user on a social network, reactions or opinions of the user published on the Internet, and
   possibly one or more intensity values V_{1,1}, V_{2,1}, . . . , V_{K,1} assigned to at least one human sense SN1, with K≥1,
an access interface IAu for accessing the memory STT and possibly the sensory profile database BDU of the user UT, if this database exists,
possibly an association module ASSu configured to associate at least one word entered in the request with at least one of the intensity values V_{1,1}, V_{2,1}, . . . , V_{K,1} assigned to at least one human sense SN1,
a content rendering module RES configured to render a visual content item on the screen of the interface IU or a sound content item via one or more loudspeakers of the interface IU.

Since the association module ASSu is optional, it is shown in dashed lines in FIG. 2.

In the example shown, the memory STTu is installed in the terminal TER. As an alternative, the memory STTu may be made accessible to the terminal TER, via the network RC or any other wireless or non-wireless network, depending on the envisaged implementation, for example if the terminal TER does not have the hardware resources and software resources needed to store this information.

On initialization, the code instructions of the computer program Pgu are for example loaded into a RAM memory (not shown), before being executed by the processor PROCu. The processor PROCu of the processing unit UTRu implements in particular the following actions, as part of the communication method that will be described below, according to the instructions of the computer program Pgu:
geolocating the user UT using the module LOC,
entering the profile PROF_SENS_UT associated with the user UT, via the interface IU,
entering a search request for a public place via the interface IU, said request comprising at least one type of place and at least one word characterizing the type of place,
storing, in the memory STTu or in the database BDU, via the access interface IAu, the sensory profile PROF_SENS_UT associated with the user UT, said profile comprising one or more intensity values V_{1,1}, V_{2,1}, . . . , V_{K,1} assigned to at least one human sense SN1,
possibly associating said at least one word with an intensity value, from among the intensity values V_{1,1}, V_{2,1}, . . . , V_{K,1}, using the association module ASSu,
transmitting the search request to the communication equipment EC, via the network RC, using the interface COMu,
receiving, from said equipment EC, via the interface COMu, a content item comprising identification information in relation to the one or more public places selected by the communication equipment EC,
rendering the content item, using the content rendering module RES, via the user interface IU.

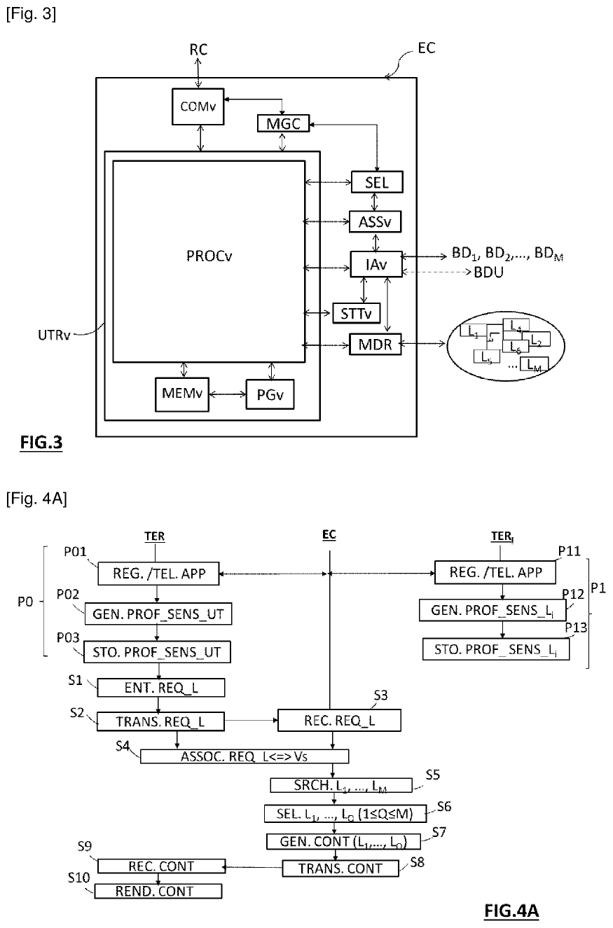

The simplified structure of the abovementioned communication equipment EC will now be described with reference to FIG. 3.

The equipment EC comprises:
a communication interface COMv configured to communicate, via the communication network RC of FIG. 1, with the terminal TER,
a search module MDR configured to search, in the network RC, for one or more public places L₁, . . . , L_{M} that has/have a type that corresponds to the type of public place contained in a search request for a public place sent by the terminal TER and that has/have a sensory profile associated with the type of public place,
a selection module SEL configured to select, from among the one or more public places found by the search module MDR, the one or more corresponding best to the sensory profile of the user UT,
a memory STTv configured to store the type of place contained in the request and to store either said at least one word or one or more intensity values V₁₁, V₂₁, . . . , V_{K1} assigned to at least one human sense SN1 that has or have been associated with said at least one word,
an access interface IAv for accessing:
   the memory STTv,
   the databases BD₁, BD₂, . . . , BD_{M},
   and possibly the sensory profile database BDU of the user UT, if this database exists,
possibly an association module ASSv configured to associate at least one word entered in the request with at least one of the intensity values V_{1,1}, V_{2,1}, . . . , V_{K,1} assigned to at least one human sense SN1,
a content generation module MGC configured to generate a content item comprising identification information in relation to the one or more public places selected as corresponding best to the sensory profile of the user UT.

In the example shown, such a memory STTv is installed in the communication equipment EC. As an alternative, the memory STTv may be made accessible to the communication equipment EC, via the network RC or any other wireless or non-wireless network, depending on the envisaged implementation, for example if the equipment EC does not have the hardware resources and software resources needed to store this information.

Since the module ASSv is optional, it is shown in dashed lines in FIG. 3.

According to one particular embodiment of the disclosed technology, the actions executed by the communication equipment EC are implemented by instructions of a computer program PGv. For this purpose, the equipment EC has the conventional architecture of a computer and comprises in particular a memory MEMv, a processing unit UTRv, equipped for example with a processor PROCv, and driven by the computer program PGv stored in memory MEMv. The computer program PGv comprises instructions for performing the following actions, as part of the communication method that will be described below, according to the instructions of the computer program PGv:
receiving a search request from the terminal TER, via the communication interface COMv, said request comprising at least one type of place, at least one word characterizing the type of place and/or one or more intensity values V_{1,1}, V_{2,1}, . . . , V_{K,1} assigned to at least one human sense SN1,
possibly storing, in the memory SSTv, said type of place, via the access interface IAv, said at least one word and/or the one or more intensity values V_{1,1}, V_{2,1}, . . . , V_{K,1} assigned to at least one human sense SN1,
accessing the database BDU, via the access interface IAu, if the one or more intensity values V_{1,1}, V_{2,1}, . . . , V_{K,1} are not contained in the search request and associating, via the module ASSv, said at least one word with at least one of the intensity values V_{1,1}, V_{2,1}, . . . , V_{K,1} assigned to at least one human sense SN1,
accessing one or more of the databases BD₁ to BD_{M}, via the access interface IAv,
searching, in the network RC, via the search module MDR, for the one or more public places L₁, . . . , L_{M} that has/have a type that corresponds to the type of public place contained in the search request,
selecting, by way of the module SEL, from among the one or more public places found by the search module MDR, the one or more public places corresponding best to the sensory profile of the user UT,
generating, by way of the module MGC, a content item comprising identification information in relation to the one or more public places selected as corresponding best to the sensory profile of the user UT,
transmitting the generated content item to the terminal TER, via the network RC, using the communication interface COMv.

On initialization, the code instructions of the computer program PGv are for example loaded into a RAM memory (not shown) before being executed by the processor PROCv. The processor PROCv of the processing unit UTRv implements in particular the abovementioned actions, according to the instructions of the computer program PGv.

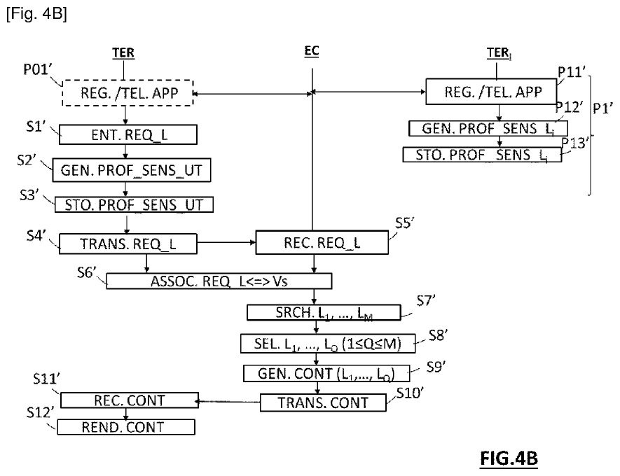

The sequencing of a communication method, according to one particular embodiment of the disclosed technology, will now be described with reference to FIG. 4A together with FIGS. 1 to 3.

During a preliminary configuration phase P0 specific to the user UT, said user connects, at P01, via the network RC, to the communication equipment EC, in order to register with the service for searching for public places using sensory criteria. The user is able to connect using their terminal TER or any other dedicated communication terminal, such as for example a personal computer such as a PC, a tablet, etc.

The user UT then registers with this service by providing in particular a communication identifier associated with their communication terminal TER, such as for example an MSISDN (Mobile Station International Subscriber Directory Number) number, an instant messaging identifier, an e-mail identifier, a MAC (Media Access Control) address, etc.

Like any process of registering with a service, the user UT may also provide personal information, such as for example their age, their gender, their place of residence, etc.

As an alternative or in addition to this operation, the user UT may download an application APP dedicated to searching for public places according to sensory criteria to their terminal TER, from the communication equipment EC.

In this preliminary configuration phase P0, the user UT, at P02, may generate their sensory profile PROF_SENS_UT via a dedicated interface offered by the communication equipment EC or the application APP. Such a profile contains information characterizing the preferences of the user UT in relation to at least one human sense from among the following five human senses:
SN1: Smell,
SN2: Sight,
SN3: Hearing,
SN4: Taste,
SN5: Touch.

For the sense of smell SN1, the user UT assigns k1 intensity values V_{1,1}, V_{2,1}, . . . , V_{k1,1} to C_{1,1}, C_{2,1}, . . . , C_{k1,1} smell categories, respectively.

For the sense of sight SN2, the user UT assigns k2 intensity values V_{1,2}, V_{2,2}, . . . , V_{k2,2} to C_{1,2}, C_{2,2}, . . . , C_{k2,2} visual categories, respectively.

For the sense of hearing SN3, the user UT assigns k3 intensity values V_{1,3}, V_{2,3}, . . . , V_{k3,3} to C_{1,3}, C_{2,3}, . . . , C_{k3,3} sound categories, respectively.

For the sense of taste SN4, the user UT assigns k4 intensity values V_{1,4}, V_{2,4}, . . . , V_{k4,4} to C_{1,4}, C_{2,4}, . . . , C_{k4,4} taste categories, respectively.

For the sense of touch SN5, the user UT assigns k5 intensity values V_{1,5}, V_{2,5}, . . . , V_{k5,5} to C_{1,5}, C_{2,5}, . . . , C_{k5,5} touch categories, respectively.

The sensory profile PROF_SENS_UT associated with the user UT is generated for example in the form of the following table [TAB]:

TABLE 1
SN1
Smell

| | |
|---|---|
| C_{1.1}: Perfumed | V_{1.1} = 10/10 |
| C_{2.1}: Woody, resinous | V_{2.1} = 8/10 |
| C_{3.1}: Fruity, other than lemon | V_{3.1} = 8/10 |
| C_{4.1} = Nauseating | V_{4.1} = 1/10 |
| C_{5.1}: Chemical | V_{5.1} = 3/10 |
| C_{6.1}: Menthol, peppermint | V_{6.1} = 9/10 |
| C_{7.1}: Sweet | V_{7.1} = 8/10 |
| C_{8.1}: Popcorn | V_{8.1} = 5/10 |
| C_{9.1}: Lemony | V_{9.1} = 2/10 |
| C_{10.1}: Acrid, rotten | V_{10.1}= 0/10 |

SN2
Sight

| | |
|---|---|
| C_{1.2}: Incandescent lamps | V_{1.2} = 8/10 |
| C_{2.2}: Halogen lamps | V_{2.2} = 0/10 |
| C_{3.2}: Compact fluorescent lamps | V_{3.2} = 5/10 |
| C_{4.2}: LED lamps | V_{4.2} = 8/10 |

SN3
Hearing

| | |
|---|---|
| C_{1.3}: Silence | 0 dB ≤ V_{1.3} < 10 dB |
| C_{2.3}: Quiet, whispering outdoors | 10 dB ≤ V_{2.3} < 20 dB |
| C_{3.3}: countryside, no wind through the trees | 20 dB ≤ V_{3.3} < 30 dB |
| C_{4.3}: countryside, slight breeze | 30 dB ≤ V_{4.3} < 40 dB |
| C_{5.3}: peaceful indoors | 40 dB ≤ V_{5.3} < 50 dB |
| C_{6.3}: quiet indoors | 50 dB ≤ V_{6.3} < 60 dB |
| C_{7.3}: moving cars | 60 dB ≤ V_{7.3} < 70 dB |
| C_{8.3}: motorcycles or tractors nearby | 70 dB ≤ V_{8.3} < 100 dB |
| C_{9.3}: concert | V_{9.3}≥ 100 dB |

SN4
Taste

| | |
|---|---|
| C_{1.4}: Sour | V_{1.4} = 0/10 |
| C_{2.4}: Bitter | V_{2.4} = 2/10 |
| C_{3.4}: Fatty | V_{3.4} = 8/10 |
| C_{4.4}: Savory | V_{4.4} = 9/10 |
| C_{5.4}: Sweet | V_{5.4} = 5/10 |
| C_{6.4}: Umami | V_{6.4} = 8/10 |

SN5
Touch

| | |
|---|---|
| C_{1.5}: Texture | V_{1.5} > 8/10 |
| C_{2.5}: Consistency | V_{2.5} < 2/10 |
| C_{3.5}: Heat | V_{3.5} > 7/10 |

In the table [TAB], the sensory profile relating to the sense of smell SN1 is for example modeled according to 10 categories C_{1,1} to C_{10,1}, the user UT assigning each of these 10 categories a score V_{1,1} to V_{10,1} of between 0 and 10 characterizing the intensity of each category. For example, the value V_{2.1}=8/10 assigned to the category C_{2.1} “woody, resinous” signifies that the user UT is very fond of the smell category “woody, resinous”.

In the table [TAB], the sensory profile relating to the sense of sight SN2 is for example modeled according to 4 categories C_{1,2} to C_{4,2}, the user UT assigning each of these 4 categories a score V_{1,2} to V_{4,2} of between 0 and 10 characterizing the intensity of each category. For example, the value V_{2.2}=0/10 assigned to the category C_{2.2} “halogen lamps” signifies that the user UT does not like the category “halogen lamps” at all.

In the table [TAB], the sensory profile relating to the sense of hearing SN3 is for example modeled according to 9 categories C_{1,3} to C_{9.3}, the user UT assigning each of these 9 categories an intensity value bounded by two decibel values. For example, the value 10 dB≤V_{2,3}<20 dB assigned to the category C_{2,3} “Quiet, whispering outdoors” signifies that the user UT gives more preference to outdoor public places with low ambient noise.

In the table [TAB], the sensory profile relating to the sense of taste SN4 is for example modeled according to 6 categories C_{1,4} to C_{6,4}, which correspond respectively to the 6 basic tastes, the user UT assigning each of these 6 categories a score V_{1,4} to V_{6,4} of between 0 and 10 characterizing the intensity of each category. For example, the value V_{1,4}=0/10 assigned to the category C_{1,4} “sour” signifies that the user UT hates this taste.

In the table [TAB], the sensory profile relating to the sense of touch SN5 targets touch by hand, and is for example modeled according to 3 categories C_{1,3} to C_{3,3} that correspond respectively to:
the texture of an element (for example the furniture in a place, the equipment in a place, etc.), which is evaluated by touch (for example sharp, smooth, soft, rough, etc.),
the consistency of the element, which is evaluated by pressure (for example hard, soft, squidgy, etc.),
temperature (for example hot, warm, cold).

The user UT assigns each of these 3 categories a score V_{1.5} to V_{3.5} of between 0 and 10 characterizing the intensity of each category. For example, the values V_{1,5}>8/10 assigned to the category C_{1,5} “texture”, V_{2,5}<2/10 assigned to the category C_{2.5} “consistency”, V_{3,5}>7/10 assigned to the category C_{3,5} “heat” signify that the user UT likes rustic public places with a warm side.

The profile PROF_SENS_UT as modeled above in the table [TAB] may be generated once and for all and may be used as it is when implementing the communication method that will be described below. For example, with regard to the sense of hearing SN3, a user UT may systematically hate noisy places, regardless of the time of day.

In one variant embodiment, the profile PROF_SENS_UT may be variable over time. For this purpose, the user UT may for example generate a profile PROF_SENS_UT for one or more time slots during the day, for example the following three profiles:
PROF_SENS_Uta for the time slot 8:00-12:00 and 14:00-19:00;
PROF_SENS_Utb for the slot 12:00-14:00;
PROF_SENS_Utc for the time slot 19:00-3:00.

Depending on the choices of the user UT, each of these 3 profiles may comprise for example a number of human senses less than the 5 senses given in the table [TAB], a number of categories per sense less than that given in the table [TAB], and category scores different from those assigned in the table [TAB].

Thus, for example, a user UT may appreciate that a place is relatively quiet, for example a neighborhood restaurant that the user UT visits on their lunch break during their working day, or on the contrary relatively noisy in the evening, when they visit a restaurant, a bar, etc. with friends.

At the end of preliminary step P02 of generating the sensory profile PROF_SENS_UT of the user UT, the table [TAB] is stored, at P03, in the database BDU and/or in the memory STTu of the terminal TER.

In a manner similar to the preliminary configuration phase P0 specific to the user UT, a preliminary configuration phase P1 specific to an administrator/manager or owner of a given public place Lᵢ, from among the abovementioned M public places, is implemented. For this purpose, the administrator/manager connects, at P11, via the network RC, to the communication equipment EC in order to register the public place Lᵢ with the service for searching for public places using sensory criteria. The administrator/manager may connect using a communication terminal TERᵢ, such as for example a smartphone, a personal computer such as a PC, a tablet, etc.

The user UT then registers with this service by providing in particular information relating to the public place Lᵢ, such as for example address, opening hours, prices, etc.

As an alternative or in addition to this operation, the administrator/manager may download an application APP dedicated to the management of the public place Lᵢ to their terminal TERᵢ, from the communication equipment EC, as part of the communication method according to the disclosed technology.

In this preliminary configuration phase P1, the administrator/manager may, at P12, generate a sensory profile PROF_SENS_Lᵢ associated with the public place Lᵢ via a dedicated interface offered by the communication equipment EC or the application APP. According to the disclosed technology, such a profile contains information characterizing the public place Lᵢ in relation to at least one human sense from among the following five human senses:
SN1: Smell,
SN2: Sight,
SN3: Hearing,
SN4: Taste,
SN5: Touch.

For the sense of smell SN1, the administrator/manager assigns k1 intensity values V_{1,1}, V_{2,1}, . . . , V_{k1,1} to C_{1,1}, C_{2,1}, . . . , C_{k1,1} smell categories, respectively.

For the sense of sight SN2, the administrator/manager assigns k2 intensity values V_{1,2}, V_{2,2}, . . . , V_{k2,2} to C_{1,2}, C_{2,2}, . . . , C_{k2,2} visual categories, respectively.

For the sense of hearing SN3, the administrator/manager assigns k3 intensity values V_{1,3}, V_{2,3}, . . . , V_{k3,3} to C_{1,3}, C_{2,3}, . . . , C_{k3,3} sound categories, respectively.

For the sense of taste SN4, the administrator/manager assigns k4 intensity values V_{1,4}, V_{2,4}, . . . , V_{k4,4} to C_{1,4}, C_{2,4}, . . . , C_{k4,4} taste categories, respectively.

For the sense of touch SN5, the administrator/manager assigns k5 intensity values V_{1,5}, V_{2,5}, . . . , V_{k5,5} to C_{1,5}, C_{2,5}, . . . , C_{k5,5} touch categories, respectively.

The sensory profile PROF_SENS_Lᵢ associated with the place Lᵢ is generated for example in the form of the following table [TABᵢ]:

TABLE 2
SN1
Smell

| | |
|---|---|
| C_{1.1}: Perfumed | V_{1.1} = 2/10 |
| C_{2.1}: Woody, resinous | V_{2.1} = 0/10 |
| C_{3.1}: Fruity, other than lemon | V_{3.1} = 4/10 |
| C_{4.1} = Nauseating | V_{4.1} = 0/10 |
| C_{5.1}: Chemical | V_{5.1} = 3/10 |
| C_{6.1}: Menthol, peppermint | V_{6.1} = 4/10 |
| C_{7.1}: Sweet | V_{7.1} = 8/10 |
| C_{8.1}: Popcorn | V_{8.1} = 0/10 |
| C_{9.1}: Lemony | V_{9.1} = 2/10 |
| C_{10.1}: Acrid, rotten | V_{10.1} = 0/10 |

SN2
Sight

| | |
|---|---|
| C_{1.2}: Incandescent lamps | V_{1.2} = 0/10 |
| C_{2.2}: Halogen lamps | V_{2.2} = 0/10 |
| C_{3.2}: Compact fluorescent lamps | V_{3.2} = 0/10 |
| C_{4.2}: LED lamps | V_{4.2} = 8/10 |

SN3
Hearing

| | |
|---|---|
| C_{1.3}: Peaceful indoors | 40 dB ≤ V_{1.3} < 50 dB |
| C_{2.3}: Quiet, whispering outdoors | 50 dB ≤ V_{2.3} < 60 dB |

SN4
Taste

| | |
|---|---|
| C_{1.4}: Sour | V_{1.4} = 0/10 |
| C_{2.4}: Bitter | V_{2.4} = 0/10 |
| C_{3.4}: Fatty | V_{3.4} = 7/10 |
| C_{4.4}: Savory | V_{4.4} = 0/10 |
| C_{5.4}: Sweet | V_{5.4} = 8/10 |
| C_{6.4}: Umami | V_{6.4} = 0/10 |

SN5
Touch

| | |
|---|---|
| C_{1.5}: Texture | V_{1.5} < 2/10 |
| C_{2.5}: Consistency | V_{2.5} > 8/10 |
| C_{3.5}: Heat | V_{3.5} > 7/10 |

The table [TABᵢ] has the same format as the abovementioned table [TAB]. For this reason, it will not be described again.

If for example the public place Lᵢ is an indoor tea room:
for the sensory profile relating to the sense of smell SN1, for example the value V_{7.1}=8/10, assigned to the category C_{7.1} “sweet”, signifies that the tea room has a predominantly sweet smell,
for the sensory profile relating to the sense of sight SN2, for example the value V_{4.2}=8/10, assigned to the category C_{4.2} “LED lamps”, signifies that the tea room is lit mostly by LED lamps,
for the sensory profile relating to the sense of hearing SN3, for example the value 50 dB≤V_{2,3}<60 dB assigned to the category C_{2.2} “quiet indoors” signifies that the ambient noise in the tea room is low,
for the sensory profile relating to the sense of taste SN4, for example the value V_{5.4}=8/10 assigned to the category C_{5.4} “sweet” signifies that the food and/or drinks offered in this tea room mostly taste sweet,
for the sensory profile relating to the sense of touch SN5, for example the value V_{2.5}>8/10, assigned to the category C_{2.5} “consistency”, signifies that the furniture is quite comfortable and soft.

The profile PROF_SENS_Lᵢ as modeled above in the table [TABᵢ] may be generated once and for all and may be used as it is when implementing the communication method that will be described below.

In one variant embodiment, the profile PROF_SENS_Lᵢ may be variable over time. For this purpose, the administrator/manager or owner may for example generate a profile PROF_SENS_Lᵢ for one or more time slots during the day, for example the following two profiles:
PROF_SENS_Lᵢa for the time slot 8:00-16:00, where the intensity values V_{1,2} and V_{2,2} correspond to those in the table [TABᵢ] to characterize low ambient noise in this time slot,
PROF_SENS_Lᵢb for the slot 16:00-18:00, where an intensity value V_{3.2} will be made greater than 60 dB to characterize the fact that, at meal time, ambient noise is high.

Depending on the choices of the administrator/manager or owner, each of these 2 profiles may comprise for example a number of human senses less than the 5 senses given in the table [TABᵢ], a number of categories per sense less than that given in the table [TABᵢ], and category scores different from those assigned in the table [TABᵢ].

Thus, for example, the administrator/manager of the place Lᵢ may decide, during a refit or maintenance work in the public place Lᵢ, to modify the type of lighting and/or the intensity of the lighting, to add savory pies to the menu, to change the furniture to give it a more rustic character, etc.

At the end of the preliminary step P12 of generating the sensory profile PROF_SENS_Lᵢ, the table [TABᵢ] is stored, at P13, in a database BDᵢ and/or in the memory STTv of the communication equipment EC.

At the end of the abovementioned configuration phases P0 and P1, the communication method e takes place as follows.

At S1, the user UT enters a search request REQ_L for a public place on their terminal TER using the user interface IU. This may be a textual or oral request. A request REQ_L may for example be of the type below:
“I would like to have lunch with my friend, do you know of a quiet restaurant in the city center?”;
“I hate the strong smell of chlorine in my swimming pool; do you know of another one that wouldn't have this problem?”;
“I hate the halogen lighting in my gym, can anyone recommend a venue with less aggressive lighting?”,
“I want to read in a public garden near me”.

At S2, the communication interface COMu of the terminal TER transmits the request REQ_L to the communication equipment EC, via the network RC. The request REQ_L may contain geolocation information in relation to the user UT, which has been determined by the localization module LOC.

At S3, the communication equipment EC receives this request via its communication interface COMv.

At S4, an association is implemented between at least one word contained in the request REQ_L and one or more intensity values assigned to at least one of the five human senses that were given in the table [TAB].

According to a first embodiment, such an association S4 is implemented by the terminal TER prior to the transmission S2 of the request REQ_L. For this purpose, depending on the one and/or more words contained in the request REQ_L, the terminal TER accesses, via the access interface IAu, the profile PROF_SENS_UT of the user, which is stored, depending on the envisaged embodiment, either in the memory STTu of the terminal TER or in the database BDU. The module ASSu of the terminal TER then selects, from the profile PROF_SENS_UT, the one or more intensity values Vs best suited to the content of the request REQ_L, and the request REQ_L that is transmitted, at S2, to the communication equipment EC contains this or these one or more intensity values.

According to a second embodiment, such an association S4 is implemented by the communication equipment EC following the receipt S3 of the request REQ_L. For this purpose, depending on the one and/or more words contained in the request REQ_L and on the communication identifier associated with the terminal TER, which is also transmitted in the request REQ_L, the communication equipment EC accesses, via the access interface IAv, the database BDU containing the profile PROF_SENS_UT of the user UT. The association module ASSv of the communication equipment EC then selects, from the profile PROF_SENS_UT, the one or more intensity values Vs best suited to the one or more words contained in the request REQ_L.

At S5, the search module MDR of the communication equipment EC searches, via the network RC, for one or more public places from among the M public places the corresponding sensory profiles of which are accessible in the databases BD₁ to BD_{M}. In particular, the module MDR searches for the one or more public places L₁, . . . , L_{M} that has/have a type corresponding to the type of public place contained in the search request REQ_L, for example “restaurant”, “swimming pool”, “gym”, “public garden”, etc., after accessing the databases BD₁ to BD_{M}, via the access interface IAv.

At S6, the selection module SEL selects, from among the one or more public places found by the search module MDR, one or Q public places L₁, . . . , L_{Q} from among M, such that 1≤Q≤M, the one or more intensity values Vs' of which are closest to the one or more values Vs selected at S4 from the sensory profile PRO_SENS_UT of the user UT.

At S7, the module MGC of the communication equipment EC generates a content item CONT comprising identification information in relation to the one/Q public places selected at S6. For example, this may be a Web page listing the name and/or the address of the selected one or Q public places in order of relevance with respect to the content of the request RQ_L, a geographical map identifying the selected one or Q public places, with their respective names and addresses being indicated, a link to an audio file orally stating the name and/or the address of the selected one or Q public places, an audio file orally stating the name and/or the address of the selected one or Q public places, etc.

At S8, the communication interface COMv of the communication equipment EC transmits the content item CONT to the terminal TER via the network RC.

At S9, the terminal TER receives the content item CONT via its communication interface COMu.

At S10, the rendering module RES of the terminal TER renders the content item CONT on a screen of the user interface IU, if the content item CONT is of textual or graphical type, or else orally via at least one loudspeaker of the user interface IU, if the content item CONT is of audio type.

In the embodiment that has just been described above, some actions, for example actions S4, S5, S6, may be implemented using a neural network, be based on deep learning technology or on statistical learning technology, etc.

The sequencing of a communication method, according to another particular embodiment of the disclosed technology, will now be described with reference to FIG. 4B together with FIGS. 1 to 3.

According to this other embodiment, the preliminary configuration steps P02 and P03 of FIG. 4A are not implemented. The sensory profile PROF_SENS_UT is then generated upon each search request for a public place entered by the user UT.

The communication method according to this other embodiment may contain a preliminary step P01′ of the user UT registering beforehand with the communication equipment EC. Since this step is identical to step P01 of FIG. 4A, it will not be described again. Since this step P01′ is optional, it is shown in dashed lines in FIG. 4B.

In a manner identical to the embodiment of FIG. 4A, the terminal TERᵢ of the administrator/manager or owner of a place Lᵢ implements a preliminary configuration phase P1′, identical to the preliminary configuration step P1. For this purpose, the preliminary configuration phase P1′ comprises, on the part of the manager/administrator or owner of a public place Lᵢ, actions P11′, P12′, P13′ that are identical to the actions P11, P12, P13 described with reference to FIG. 4A, respectively. A table [TABᵢ′] identical to the table [TABᵢ] is then generated during the preliminary configuration phase P1′.

At the end of the preliminary steps P01′, where applicable, and P11′, P12′, P13′, the communication method according to this other embodiment implements the following.

At S1′, the user UT enters a search request REQ_L for a public place on their terminal TER using the user interface IU. Since such an action is identical to the action S1 of FIG. 4A, it will not be described further.

At S2′, a sensory profile PROF_SENS_UT of the user UT is generated as follows. A digital questionnaire is rendered on the user interface IU, either in the form of sections to be filled in by the user UT or in the form of a series of questions to be answered by the user UT. The questions are relevant to one or more words entered by the user UT at S1′. Thus, for example, if the request RQ_L entered at S1′: “Go for a drink in my neighborhood”, the user UT is for example asked the following series of questions:
“When you go out to a bar with your friends, do you prefer:
   A bar without music, a very peaceful atmosphere;
   A bar with background music that isn't too loud, a relatively quiet atmosphere;
   A bar with loud music, a party atmosphere!”.

After providing a response to this questionnaire, a sensory profile PROF_SENS_UT of the user UT is generated either by the terminal TER or by the communication equipment EC, in the form of a table [TAB′] having the same format as the abovementioned table [TAB]. Such a table [TAB′] may be incomplete compared to the table [TAB] if the request RQ_L concerns for example just a single human sense, for example hearing SN3 in the example described here.

In an alternative or additional embodiment, the table [TAB′] may be generated, at S2′, on the fly or over time by utilizing certain digital traces generated by the user UT when said user communicates using the communication terminal TER or any other communication terminal, for example via their e-mail, via SMS (Short Message Service) messages, via videos, comments, etc. that are posted on social networks, in particular in relation to public places, etc., provided of course that the terminal TER has been identified in the communication network RC. Such messages, comments or opinions are for example as follows:
“I went to swimming pool “A” last night and it stinks of chlorine”,
“Restaurant B is very noisy on Saturday nights, but the furniture there is very comfortable”,
“Park “C” in the city center is very well lit and smells slightly of lemon.”

Other data, such as for example data stored in the memory STTu of the terminal TER, may also be utilized to generate the table [TAB′]. These may be for example information from the call log of the terminal TER, cookies, geolocation information determined by the geolocation module LOC, etc.

In another alternative or additional embodiment, the table [TAB′] may be generated, at S2′, on the fly or over time by utilizing certain digital traces left by the user UT as mentioned above, and based on learning, for example by an artificial intelligence module using in particular machine learning techniques and various natural language processing operations in particular in the case where the actions of the user UT with their terminal TER are written or oral communications, at least one particular personality type of the user, said at least one type being correlated with certain sensory preferences of the user UT. The assignment of one or more personality types to the user is based for example on the Big 5 model as described in the document: “Goldberg, L. R. (1981). Language and individual differences: The search for universals in personality lexicons. In Wheeler (ed.), Review of Personality and Social Psychology, Vol. 1, 141-165. Beverly Hills, CA: Sage”. This model makes it possible describe personality using the following five main types:
openness: appreciation of art, of emotion, of adventure, of uncommon ideas, curiosity and imagination;
conscientiousness: self-discipline, dutiful, organization rather than spontaneity; goal-oriented;
extroversion: energy, positive emotions, tendency to seek stimulation and the company of others, go-getter;
agreeableness: tendency to be compassionate and cooperative rather than suspicious and antagonistic toward others;
neuroticism: tendency to easily experience unpleasant emotions such as anger, worry or depression.

After learning personality types based on this model, the user UT is evaluated differently five times, according to the five abovementioned types. In practice, a score for each of the five types (for example 1, 2, 3, 4 or 5) is assigned to the user. The personality of the user is therefore described by five different scores (a score relating to openness, a score relating to conscientiousness, a score relating to extroversion, a score relating to agreeableness and lastly a score relating to neuroticism). Thus, for example for the “extroversion” type, the user is assigned a score ranging from 1 to 5 depending on their level of extroversion, the minimum score 1/5 corresponding to a very introverted personality and the maximum score 5/5 corresponding to a very extroverted personality. The artificial intelligence module is furthermore configured to correlate the various scores assigned to the personality types of the user UT with at least one intensity value for at least one of the five human senses from among the abovementioned senses SN1 to SN5. In one exemplary embodiment, if, from digital traces, the user UT is identified as being very introverted, the score 1/5 having been assigned to “extraversion”, the artificial intelligence module will deduce from this that the user UT tends to search for public places without excessively strong lighting and/or with low ambient noise. Therefore, the artificial intelligence module will correlate the score 1/5 assigned to “extraversion” with for example intensity values V_{1,2} to V_{4,2} for the sense of sight SN2 of the order of 2/10 and with intensity values 40 dB≤V_{1,3}<50 dB and 50 dB≤V_{2,3}<60 dB for the sense of hearing SN3.

At the end of step S2′ of generating the sensory profile PROF_SENS_UT, the table [TAB′] is stored, at S3′, in the database BDU and/or in the memory STTu of the terminal TER.

The communication method according to this other embodiment continues with the implementation of the actions S4′ to S12′, which are identical or similar to the actions S2 to S10 of FIG. 4A, respectively, and which therefore will not be described again.

Although the disclosed technology has been described above with reference to certain specific embodiments, it will be understood that the disclosed technology is not limited by the particularities of the specific embodiments but, to the contrary, that numerous variations, modifications and developments may be made in the above-described embodiments within the scope of the appended claims.

What is claimed is:

1. A method for communication between a terminal and a communication equipment, via a communication network, during which the terminal requests to obtain a content item from said equipment, said content item relating to a place open to the public, the method comprising:
transmitting, from the terminal to said equipment, via said network, a search request for at least one place open to the public, said request comprising at least one type of place and at least one word characterizing the type of place, said at least one word being associated with a first intensity value assigned to at least one human sense,
selecting, in said network, one or more places open to the public for which a second intensity value for said at least one human sense has been assigned and the second value of which is closest to the first value, and
in response to the request, receiving, in the terminal, from said equipment, a content item comprising identification information in relation to the selected one or more places.

2. The method of claim 1, wherein:
the first intensity value for said at least one human sense belongs to a profile of a user of the terminal, said profile containing sensory preferences of the user in relation to one or more human senses, and
the second intensity value for said at least one human sense belongs to a profile of at least one place, said profile containing sensory characteristics specific to said place, in relation to one or more human senses.

3. The method of claim 2, wherein the profile of the user of the terminal is generated in one go prior to the implementation of the method or is generated in association with each search request.

4. The method of claim 3, wherein the profile of the user of the terminal is generated from responses of the user to a digital questionnaire received by said terminal or another terminal from said communication equipment, said questionnaire interrogating the user about their preferences in relation to at least one human sense.

5. The method of claim 3, wherein the profile of the user of the terminal is generated from one or more messages of the user that have been published, via said communication network, the one or more messages relating to one or more places open to the public, in relation to at least one of the human senses.

6. The method of claim 3, wherein the profile of the user of the terminal is generated from one or more digital traces left by the user, during one or more communications using said terminal, via said communication network.

7. The method of claim 2, wherein the first intensity value for said at least one human sense of the profile of the user of the terminal, respectively the second intensity value for said at least one human sense of the profile of said at least one place, are variable or invariable over time.

8. A communication terminal designed to communicate, via a communication network, with a communication equipment, during which the terminal requests to obtain a content item from said equipment, said content item relating to a place open to the public, the terminal configured to:
transmit, to said communication equipment, via said network, a search request for at least one place open to the public, said request comprising at least one type of place open to the public and at least one word characterizing said type of place, said at least one word being associated with a first intensity value assigned to at least one human sense, and
in response to the request, receive, from said equipment, via said network, a content item comprising identification information in relation to one or more places for which a second intensity value for said at least one human sense has been assigned and the second value of which is closest to the first value.

9. Communication equipment designed to communicate, via a communication network, with a communication terminal, during which the terminal requests to obtain a content item from said equipment, said content item relating to a place open to the public, said equipment configured to:
receive, from the terminal, via said network, a search request for at least one place open to the public, said request comprising at least one type of place open to the public and at least one word characterizing said type of place, said at least one word being associated with a first intensity value assigned to at least one human sense,
select, in said network, one or more places open to the public for which a second intensity value for said at least one human sense has been assigned and the second value of which is closest to the first value, and
in response to the request, transmit, to said terminal, via said network, a content item comprising identification information in relation to the selected one or more places open to the public.

10. A computer comprising a processor and a memory, the memory having stored thereon program code instructions which, when executed by the processor, cause the computer to implement the communication method of claim 1.

11. A non-transitory, computer-readable medium having stored thereon instructions which, when executed by a processor, cause the processor to implement the method of claim 1.
